(19) United States
(12) Patent Application Publication
(10) Pub. No.: US 2018/0152429 A1
(43) Pub. Date: May 31, 2018

(54) SYSTEMS AND METHODS FOR PUBLICLY VERIFIABLE AUTHORIZATION

(71) Applicant: Digital CC IP Pty Ltd., Joondalup (AU)

(72) Inventors: Michael A. Segal, Concord, NH (US); Alexander D. Karis, Hingham, MA (US); Neel Krishnan, Brooklyn, NY (US); Eugeni Yurievich Tsvetnenko, Mount Pleasant (AU); William R. Brindise, Rumson, NJ (US); Fabricio E. Rodriguez, Randolph, MA (US)

(21) Appl. No.: 15/577,841

(22) PCT Filed: May 30, 2016
(86) PCT No.: PCT/IB2016/000817

§ 371 Date: Nov. 29, 2017

Related U.S. Application Data
(60) Provisional application No. 62/168,648, filed on May 29, 2015.
(60) Provisional application No. 62/330,126, filed on Apr. 30, 2016.

(51) Int. Cl. H04L 29/06; H04L 9/08; H04L 9/32

(52) U.S. Cl. CPC H04L 63/08; H04L 63/0428; H04L 2463/101; H04L 9/0861; H04L 9/3213; H04L 63/102

(57) ABSTRACT

Systems and computer-implemented methods are provided for publicly verifiable authorization using a distributed public data structure. A central authorization system may include a database storing authorization records and may be configured to receive a first grant request from an origin device. The grant request may include contact information for a second user. The central authorization system may publish an encrypted message documenting the first grant request for incorporation into the distributed public data structure. The central authorization system may also provide a perfection code for decrypting the message to the second user. The central authorization system may receive a request to perfect the first grant request from a destination device. The central authorization system may publish a message documenting perfection of the first grant request for incorporation into the distributed public data structure. The central authorization system may grant the authorization to the second user.

This application claims the benefit of U.S. Provisional applications 62/168,648 filed May 29, 2015 and 62/330,126 filed Apr. 30, 2016. Each patent application identified above is hereby incorporated by reference in its entirety.

### TECHNICAL FIELD

The envisioned systems and computer-implemented methods concern management of digital grants of authorization. As disclosed herein, distributed public data structures may be used to ensure non-repudiable and publicly verifiable grants of authorization.

### BACKGROUND

Effective systems and methods for management of digital grants of authorization may depend on the shared trust of users. Users known to each other may develop trust over repeated interactions. But such systems often involve limited interactions between users not known to each other, inhibiting the formation of trust. Systems for providing feedback about users may encourage good behavior and increase trust, but such systems may be manipulated. Such systems also fail to address the lack of a publicly verifiable, impartial record to resolve disputes between users. But such a record may be expensive, and users must be willing to trust the entity maintaining the record. Consequently, there is a need for improved systems and methods for publicly verifiable authorization.

### SUMMARY

The disclosed embodiments concern improved systems and methods for publicly verifiable authorization. These methods and systems may incorporate messages concerning grants of authorization into a distributed public data structure, ensuring that the messages, once perfected, are non-repudiable and public. Furthermore, this distributed public data structure may be maintained by independent third parties, increasing the legitimacy of the incorporated messages and decreasing the expense of authorization.

The disclosed embodiments may include, for example, a central authorization system for publicly verifiable authorization. The system may include a database storing authorization records, at least one processor, and at least one non-transitory memory storing instructions. The instructions when executed by the at least one processor may cause the central authorization system to perform operations. These operations may include receiving, from an origin device, a first grant request comprising grant information and second user contact information. These operations may include creating an authorization request entry in the database. These operations may include publishing, to the processing nodes, an encrypted creation message for incorporation into a distributed public data structure, the encrypted creation message indicating the grant information. These operations may further include providing a grant request indication to the second user. The grant request indication may include a perfection code enabling decryption of the encrypted creation message.

In some embodiments, the central authorization system may perform further operations including receiving, from a destination device, a perfection request, the perfection request including the perfection code. The central authorization system may also perform operations including publishing, to the processing nodes, based on the received perfection request, a perfection message for incorporation into the distributed public data structure, the perfection message comprising a reference to the creation message and the perfection code. The central authorization system may perform additional operations comprising granting the first grant request by updating the authorization records according to the authorization request entry.

In some embodiments, the central authorization system may perform further operations including receiving, from a destination device, a transfer request, the transfer request comprising the perfection code. The central authorization system may also perform operations including publishing, to the processing nodes, based on the received transfer request, an encrypted transfer message for incorporation into the distributed public data structure, the encrypted transfer message comprising a reference to the creation message and the perfection code. The central authorization system may perform additional operation comprising providing a second grant request indication, the second grant request indication comprising a second perfection code enabling decryption of the encrypted transfer message.

It is to be understood that both the foregoing general description and the following detailed description are exemplary and explanatory only and are not restrictive of the disclosed embodiments, as claimed.

### BRIEF DESCRIPTION OF THE DRAWINGS

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and, together with the description, serve to explain the principles of the disclosure. In the drawings:

FIG. 1 depicts an exemplary high-level representation of a system for publicly verifiable authorization.

FIG. 2 depicts an exemplary instance of a distributed public data structure.

FIGS. 3A-3C depict exemplary messages published by the system for publicly verifiable authorization.

FIG. 4 depicts a flowchart of an exemplary method for creating a publicly verifiable grant of authorization.

FIG. 5 depicts a flowchart of an exemplary method for publicly verifiable perfection of a grant of authorization.

FIG. 6 depicts a flowchart of an exemplary method for publicly verifiable transfer of a grant of authorization.

FIG. 7 depicts an exemplary computing system for publicly verifiable authorization.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

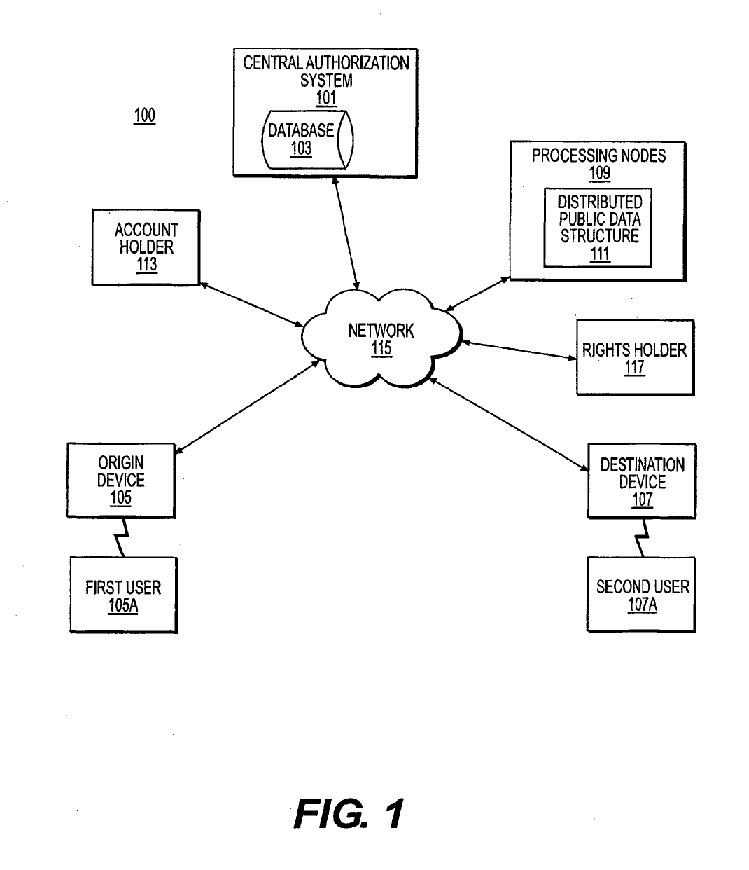

FIG. 1 depicts an exemplary high-level representation of a system for publicly verifiable authorization, consistent with disclosed embodiments. In some embodiments, authorization system 100 may be configured to manage authorization for registered users of authorization system 100 (e.g., users that have created accounts with authorization system 100). In some embodiments, first user 105a may desire to grant authorization to second user 107a. To effectuate this grant of authorization in a publicly verifiable manner, first user 105a may interact with authorization system 100 to grant authorization to second user 107a. Authorization system 100 may be configured to interact with first user 105a through origin device 105. In response to the interaction, authorization system 100 may notify second user 107a of the grant of authorization. Authorization system 100 may cause a message documenting the grant of authorization to be incorporated into distributed public data structure 111. Authorization system 100 may create an authorization request entry corresponding to the grant of authorization in database 103. In response to the notification, second user 107a may interact with authorization system 100 to perfect the grant of authorization. Authorization system 100 may be configured to interact with second user 107a through destination device 107 to perfect the grant of authorization. In some embodiments, database 103 may store authorization records for users of authorization system 100. In certain embodiments, authorizations managed by authorization system 100 may correspond to holdings of account holder system 113.

Central authorization system 101 may be configured to manage authorizations for authorization system 100, consistent with disclosed embodiments. Central authorization system 101 may include one or more computing systems, such as servers, general purpose computers, or mainframe computers. Central authorization system 101 may be standalone, or may be part of a subsystem, which may be part of a larger system. For example, central authorization system 101 may include distributed servers that are remotely located and communicate over a public network (e.g., network 115) or a dedicated private network. In some embodiments, central authorization system 101 may be implemented at least in part as a virtual system on a cloud-computing infrastructure. Consistent with disclosed embodiments, central authorization system 101 may include or communicate with one or more storage devices configured to store data and/or software instructions. The stored data and/or software instructions may include one or more software programs. Central authorization system 101 may execute the stored one or more software programs to perform one or more methods consistent with the disclosed embodiments. In certain aspects, central authorization system 101 may execute the stored one or more software programs remotely from central authorization system 101. For example, central authorization system 101 may access one or more remote devices to execute the stored one or more software programs. In certain embodiments, central authorization system 101 may be configured as a particular apparatus or system based on the storage, execution, and/or implementation of the software instructions.

Central authorization system 101 may be configured to manage one or more of requests to grant authorization, requests to revoke grants of authorization, request to perfect grants of authorization, and requests to transfer grants of authorization. In some embodiments, central authorization system 101 may be configured to receive such requests from devices, such as origin device 105 and/or destination device 107. In certain aspects, central authorization system 101 may be configured to authenticate such requests. In certain aspects, central authorization system 101 may be configured to manage such requests in exchange for compensation from one or more of first user 105a and second user 107a. In various aspects, such compensation may be incorporated into a grant or transfer of authorization. In various aspects, central authorization system 101 may be configured to provide confirmation messages in response to such requests. In various embodiments, central authorization system 101 may be configured to publish messages corresponding to such requests to processing nodes 109 for incorporation into distributed public data structure 111. In some embodiments, central authorization system 101 may be configured to access and manage database 103 to track authorizations and grants of authorization. For example, central authorization system 101 may be configured to access database 103 to update authorizations for users of authorization system 100 according to one or more grants of authorization. For example, central authorization system 101 may be configured to access database 103 to update authorizations for a user associated with origin device 105 when second user 107a perfects a grant of authorization according to grant information for the grant of authorization stored in database 103. In some embodiments, central authorization system 101 may be configured to provide indications of grants of authorization and transfers of authorization to second user 107a. In some embodiments, central authorization system 101 may be configured to expose an application programming interface, or API, for communicating with one or more other components of authorization system 100. For example, central authorization system 101 may be configured to expose an API for communicating with one or more of origin device 105 and destination device 107. As an additional example, the API may utilize the short messages service (SMS) protocol for communication. As a further example, central authorization system 101 may be configured to communicate using a website. For example, central authorization system 101 may be configured to provide a user interface accessible using network 115. As an additional example, central authorization system 101 may be configured to communicate using a web service.

Database 103 may be configured to store authorization records for access and management by central authorization system 101, consistent with disclosed embodiments. In some embodiments, database 103 may be implemented as a hierarchical database, relational database, object-oriented database, document-oriented database, graph-oriented database, or key-value database. In some embodiments, database 103 may be arranged and configured to store authorization records for users of authorization system 100. For example, database 103 may comprise an account corresponding to a user associated with origin device 105. As an additional example, database 103 may comprise an account corresponding to a user associated with destination device 107. One of skill in the art would recognize many suitable implementations of database 103, and the envisioned embodiments are not intended to be limited to a particular implementation. Accounts may indicate authorizations users of authorization system 100 may grant. In certain aspects, database 103 may be configured to store entries corresponding to requests to grant authorization. In some aspects, such authorization request entries may comprise keys, grantor information, and grant information. Grant information may indicate the extent and characteristics of any grant of authorization. Grantor information may comprise information identifying an account of a user of authorization system 100. Keys may include indices or index values, as would be known by one of skill in the art. As described in detail below, seeds for generating the cryptographic keys used to decrypt messages incorporated into distributed public data structure 111 may be used as keys for database 103.

Origin device 105 may be configured to provide a request to grant one or more authorizations to central authorization system 101, consistent with disclosed embodiments. In some aspects, a user may operate origin device 105, or direct operation of origin device 105. Origin device 105 may include, but is not limited to, a general purpose computer, computer cluster, terminal, mainframe, mobile computing device, or other computing device capable of providing a request to grant one or more authorizations to central authorization system 101. For example, a general purpose computer may include, but is not limited to, a desktop, workstation, or all-in-one system. As an additional example, a mobile computing device may include, but is not limited to, a cell phone, smart phone, personal digital assistant, tablet, or laptop. In some embodiments, origin device 105 may be a client device of another component of central authorization system 101. In some aspects, origin device 105 may be configured to provide a request to revoke a grant of one or more authorizations to central authorization system 101. As an additional example, origin device 105 may be configured to use the short messages service (SMS) protocol for communication. As a further example, origin device 105 may be configured to communicate with central authorization system 101 using a website. For example, origin device 105 may be configured to communicate using network 115 with a user interface provided by central authorization system 101. As an additional example, origin device 105 may be configured to communicate with central authorization system 101 using a web service.

First user 105a may use authorization system 100 to grant authorizations to second user 107a consistent with disclosed embodiments. First user 105a may be a person or a legal entity. In certain embodiments, first user 105a may interact with another user (not shown) to access authorization system 100 to grant authorizations. For example, first user 105a may interact with a user associated with associated with origin device 105. In various embodiments, this user may be a registered user and have an account with authorization system 100. In some embodiments, first user 105a may be associated with origin device 105. For example, first user 105a may operate origin device 105. As an additional example, first user 105a may direct or control operation of origin device 105. As a further example first user 105a may own or possess origin device 105. In various embodiments, first user 105a may be a registered user and have an account with authorization system 100. For example, first user 105a may have an account stored in database 103.

Destination device 107 may be configured to provide a request to perfect or transfer one or more authorizations to central authorization system 101, consistent with disclosed embodiments. In some aspects, a user may operate destination device 107, or direct operation of destination device 107. Destination device 107 may include, but is not limited to, a general purpose computer, computer cluster, terminal, mainframe, mobile computing device, or other computing device capable of providing a request to perfect or transfer one or more authorizations to central authorization system 101. For example, a general purpose computer may include, but is not limited to, a desktop, workstation, or all-in-one system. As an additional example, a mobile computing device may include, but is not limited to, a cell phone, smart phone, personal digital assistant, tablet, or laptop. In some embodiments, destination device 107 may be a client device of another component of central authorization system 101. As an additional example, destination device 107 may be configured to use the short messages service (SMS) protocol for communication. As a further example, destination device 107 may be configured to communicate with central authorization system 101 using a website. For example, destination device 107 may be configured to communicate using network 115 with a user interface provided by central authorization system 101. As an additional example, destination device 107 may be configured to communicate with central authorization system 101 using a web service.

Second user 107a may use authorization system 100 to perfect or transfer a grant of authorization by first user 105a consistent with disclosed embodiments. Second user 107a may be a person or a legal entity. In certain embodiments, second user 107a may interact with another user (not shown) to use authorization system 100 to grant authorizations. For example, second user 107a may interact with a user associated with associated with destination device 107. In various embodiments, this user may be a registered user and have an account with authorization system 100. In some embodiments, second user 107a may be associated with destination device 107. For example, second user 107a may operate destination device 107. As an additional example, second user 107a may direct or control operation of destination device 107. As a further example second user 107a may own or possess destination device 107. In various embodiments, second user 107a may be a registered user and have an account with authorization system 100. For example, second user 107a may have an account stored in database 103.

Processing nodes 109 may be configured to incorporate messages received from central authorization system 101 into distributed public data structure 111, consistent with disclosed embodiments. Processing nodes 109 may include, but are not limited to, computing devices using on one or more central processing units, graphical processing units, special purpose integrated circuits such as field-programmable gate array (FPGA) or application specific integrated circuits (ASIC), servers, and/or computer clusters for processing entries for the distributed public data structure. In some embodiments, processing nodes 109 may be configured to incorporate entries into distributed public data structure 111. In some embodiments, the entries may comprise messages provided by the central authorization system 101. In various embodiments, the entries may further comprise messages provided by entities unrelated to central authorization system 101.

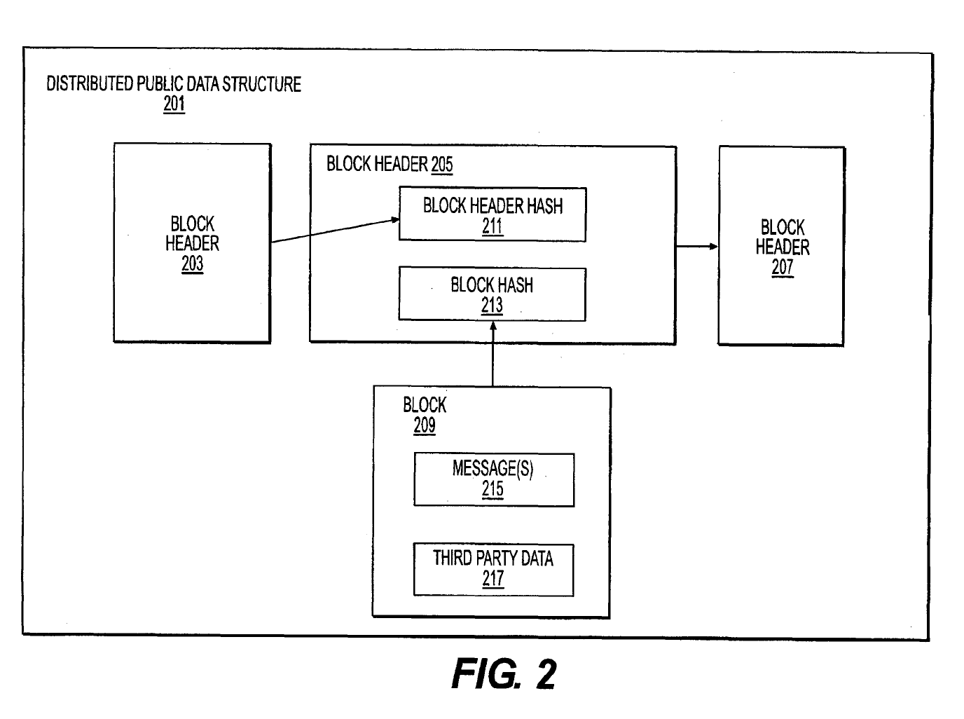

Distributed public data structure 111 may comprise multiple data structures constructed by processing node(s) 109. As described below with regard to FIG. 2, each of the multiple data structures may comprise a chain of block headers. The block headers may include information enabling public verification of messages. For example the block headers may include one or more hashes enabling authentication of a message, according to methods known to one of skill in the art. Partnering organization may review the distributed data structure and use the information to interoperate with central authorization system 101.

Account holder system 113 may be configured to maintain digital holdings, consistent with disclosed embodiments. In some embodiments, the authorizations managed by central authorization system 101 may concern these digital holdings. Account holder system 113 may include one or more computing systems, such as servers, general purpose computers, or mainframe computers. Account holder system 113 may be standalone, or it may be part of a subsystem, which may be part of a larger system. For example, account holder system 113 may include distributed servers that are remotely located and communicate over a public network (e.g., network 115) or a dedicated private network. Account holder system 113 may be configured with at least one account associated with central authorization system 101. In some aspects, account holder system 113 have limited access to information concerning an allocation of authorizations between individual users of authorization system 100 for the at least one account. For example, account holder system 113 may lack information distinguishing the authorizations allocated by authorization system 100 to first user 105a from the authorizations allocated by authorization system 100 to second user 107a. In some embodiments, account holder system 113 may be configured to conduct transactions with users of authorization system 100 that modify the contents of the at least one account associated with central authorization system 101. In some aspects, these transactions may occur directly between account holder system 113 and the users of authorization system 100. In various aspects, these transactions may occur indirectly between account holder system 113 and the users of authorization system 100. For example, these transactions may use central authorization system 101, or another system, as an intermediary.

In some embodiments, central authorization system 101 may be configured to maintain authorization records for the at least one account allocating authorizations between individual users of authorization system 100. For example, central authorization system 101 may be configured to access and manage database 103 to store authorization records allocating the contents of the at least one account among the users of authorization system 100. Central authorization system 101 may be configured to perfect grants of authorization by accessing database 103 to update stored authorization records. In some embodiments, this access may not directly affect the at least one account for authorization system 100 held by account holder system 113. In some embodiments, central authorization system 101 may be configured to access database 103 to modify authorization records associated with users of authorization system 100, when these users conduct transactions with account holder system 113.

Network 115 may be configured to provide communications between central authorization system 101, origin device 105, destination device 107, processing nodes 109, and account holder system 113, as shown in FIG. 1. For example, network 115 may be any type of network (including infrastructure) that provides communications, exchanges information, and/or facilitates the exchange of information between the above components of authorization system 100. For example, network 115 may comprise the Internet, a Local Area Network, or other suitable connection(s). Network 115 may implement different networks for communication between different elements of authorization system 100. For example, network 115 may implement a cellular network for transmitting SMS messages between central authorization system and one or more of origin device 105 and destination device 107. In some aspects, transmission of SMS messages may use services that provide status information concerning SMS message delivery. Such methods of providing status information would be known to one of skill in the art.

Rights holder system 117 may include one or more computing systems, such as servers, general purpose computers, or mainframe computers. Rights holder system 117 may be standalone, or it may be part of a subsystem, which may be part of a larger system. For example, rights holder system 117 may include distributed servers that are remotely located and communicate over a public network (e.g., network 115) or a dedicated private network. In some embodiments, a business institution (not shown) may be associated rights holder system 117. In certain embodiments, the at least one business institution may provide goods or services to a consumer or another business institution. As a non-limiting example, the business institution may comprise a manufacturer, distributor, wholesaler, retailer, or service provider. As an additional non-limiting example, the business institution may comprise a financial institution, such as a money services business, bank, credit union, savings and loan, investment bank, brokerage, or similar financial institution. In certain embodiments, rights holder system 117 may comprise a plurality of rights holder systems associated with a plurality of corresponding business institutions. For example, a first rights holder system may be associated with a first business institution and a second rights holder system may be associated with a second business institution.

Central authorization system 101 may be configured to communicate with rights holder system 117 over network 115, consistent with disclosed embodiments. In some aspects, rights holder system 117 may be configured with accounts. For example, rights holder system 117 may be configured with at least one account for at least one of the user associated with origin device 105, the user associated with destination device 107, and central authorization system 101. In certain aspects, central authorization system 101 may be configured to provide messages to rights holder system 117 concerning the accounts. In some aspects, the messages may direct rights holder system 117 to modify a parameter of the at least one account. In various aspects, central authorization system 101 may be configured to interact with the business institution through rights holder system 117. In some aspects, central authorization system 101 may be configured to provide instructions for the business institution to rights holder system 117. In some aspects, the instructions may concern provision of goods and services to the user associated with origin device 105, or another user.

Consistent with disclosed embodiments, central authorization system 101 may be configured to direct account holder system 113 to communicate with rights holder system 117. In some aspects, central authorization system 101 may be configured to direct account holder system 113 to transfer rights associated with user 105a to rights holder system 117. In various embodiments, central authorization system 101 may be configured to access database 103 to update stored rights information related to this transfer of rights. For example, central authorization system 101 may be configured to access database 103 to update stored rights information for the account corresponding to the user associated with origin device 105.

FIG. 2 depicts an exemplary instance of distributed public data structure 111, consistent with disclosed embodiments. In some embodiments, instances of distributed public data structure 111 may be distributed among one or more of processing nodes 109. This distribution may ensure that messages incorporated into distributed public data structure 111 cannot be destroyed, altered, or disavowed. In some embodiments, an instance of distributed public data structure 111 may comprise a branching chain of block headers, such as block header 203, block header 205, and block header 207 (block headers prior to block header 203 not shown for clarity). Each block header in the chain, such as block header 205, may be authenticatable based on subsequent block headers in the chain. For example, each block header may comprise a block header hash 211 computed over (in part) the hash of the prior block chain header. Thus an attempt to change a block header would require changing all of the subsequent block headers to the end of the chain. Block header hash 211 may also be computed over a block hash 213 of the entries, such as message(s) 215 and third party data 217 in block 209. Thus entries such as message(s) 215 can be verified based on block hash 213, which can be verified in turn based on block header hash 211.

Third party data 217 may comprise third party transaction data, consistent with disclosed embodiments. In certain aspects, third party data 217 may comprise transactions in a cryptocurrency, such as bitcoin, dogecoin, litecoin, and similar cryptocurrencies. In some embodiments, processing nodes 109 may be compensated according to the design of the cryptocurrency for incorporating blocks, such as block 209, into distributed public data structure 111. Consistent with disclosed embodiments, this compensation may be independent of the operations of authorization system 100. For example, the cryptocurrency may be configured to award units of the cryptocurrency to one of processing nodes 109 for successfully computing a block header hash (e.g. block header hash 211).

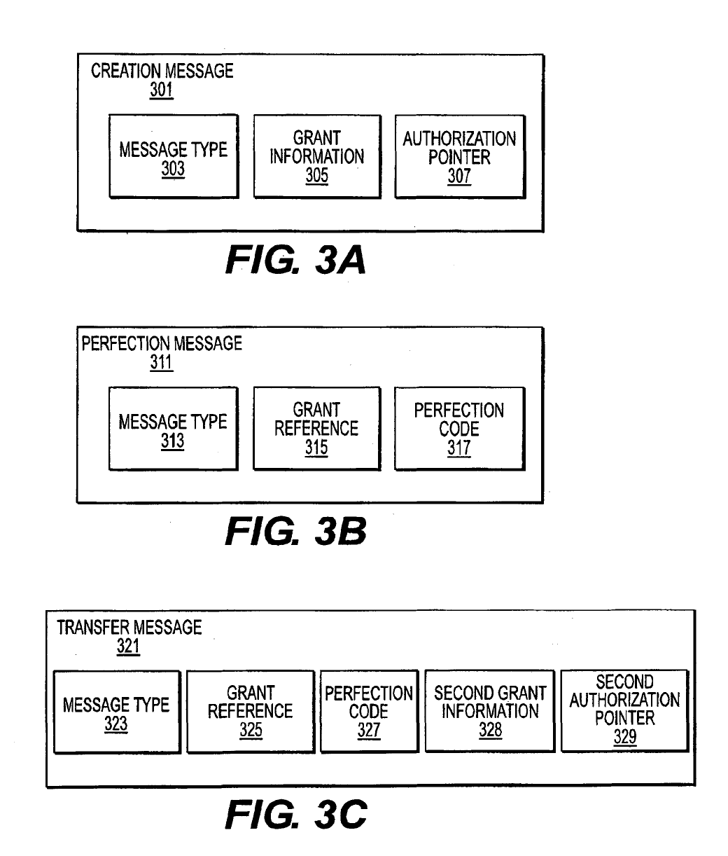

Message(s) 215 may comprise one or more of request, perfect, or transfer messages, as described below with respect to FIG. 3, consistent with disclosed embodiments. Central authorization system 101 may be configured to use a cryptocurrency transaction to package message(s) 215 for incorporation into distributed public data structure 111 In some embodiments, message(s) 215 may be packaged as payloads in cryptocurrency transactions. For example, message(s) 215 may be processed as metadata according to instructions configuring the cryptocurrency transactions. As an additional example, the instructions may be part of a challenge script. As a further example, the transaction may be a Bitcoin transaction, the instructions may comprise an opt_return script function, and incorporating the transaction into distributed public data structure 111 may cause the message to be publicly visible in distributed public data structure 111. In some embodiments, message(s) 215 may be limited in size according to the cryptocurrency protocol. As a non-limiting example, message(s) 215 may be limited to 80 bytes or less, or 40 bytes or less. In some embodiments, as discussed below with regard to FIGS. 3A-3C, message(s) 215 may be distributed among multiple transactions.

In some embodiments, the cryptocurrency transaction may be a dummy cryptocurrency transaction. In some aspects, the amount of the cryptocurrency transaction may be insignificant to the transacting parties. In various aspects, the cryptocurrency transaction may transfer cryptocurrency between accounts controlled by one or more related entities. In some aspects, the cryptocurrency transaction may concern bitcoin wallets controlled by a common entity. As a non-limiting example, central authorization system 101 may be configured to conduct at least one dummy transaction with central authorization system 101. This at least one dummy transaction may concern cryptocurrency units associated with central authorization system 101. For example, the at least one transaction may be a Bitcoin transaction, all of whose inputs redeem UTXOs with P2PKH scripts corresponding to an address associated with the central authorization system 101. In some aspects, this address may be a green address. As a further non-limiting example, the cryptocurrency transaction may be configured to output no cryptocurrency units. As would be appreciated by one of skill in the art, a dummy cryptocurrency transaction may be executed in a variety of manners, and the disclosed embodiments are not limited to a particular manner.

FIGS. 3A-3C depict exemplary messages published by authorization system 100, consistent with disclosed embodiments. In some embodiments, the exemplary messages depicted in FIGS. 3A-3C may include timestamps (not shown). In some embodiments, central authorization system 101 may be configured to generate creation message 301 (FIG. 3A) in response to a request to grant authorization. In certain aspects, creation message 301 may be configured to contain one or more of message type 303, grant information 305, and authorization pointer 307. In some aspects, message type 303 may indicate that the message corresponds to creation of a grant of authorization.

Grant information 305 may describe a grant of authorization, consistent with disclosed embodiments. In certain embodiments, grant information 305 may describe conditions on a grant of authorization. In certain aspects, conditions on a grant of authorization may include one or more of unilateral requirements, such as start times and start conditions, expiration times and expiration conditions, and limitations on perfection and transfer of authorization, and bilateral requirements, such as requirements for reciprocal grants of authorization. In certain aspects, a reciprocal grant of authorization requirement may specify one or more of start information concerning the reciprocal grant, such as a start time or start condition, expiration information concerning the reciprocal grant, such as a time limit, and grant information for the reciprocal grant, such as the characteristics of the reciprocally granted authorization and/or contact information for the grantee of the reciprocally granted authorization. Grant information 305 may indicate satisfaction of conditions on a previous grant of authorization. For example, grant information 305 may indicate satisfaction of a reciprocal grant of authorization requirement. In some aspects, central authorization system 101 may be configured to encode information about grant conditions into messages (e.g., message(s) 215) published to processing nodes 109 for incorporation into distributed public data structure 111. For example, central authorization system 101 may be configured to encode information about reciprocal grant of authorization requirements. As an additional example, central authorization system 101 may be configured to encode information about satisfaction of reciprocal grant of authorization requirements. Consistent with disclosed embodiments, this encoded information may be publicly verifiable, enabling third parties to assess the likelihood a grantee will satisfy reciprocal grant of authorization requirements. In some embodiments, central authorization system 101 may be configured to process this encoded information into ratings of grantee, such as second user 107a. Such ratings may estimate or reflect a likelihood that the grantee will fail to satisfy the reciprocal grant of authorization requirements. In certain aspects, grant information 305 may include information associated with origin device 105. For example, grant information 305 may include information describing the user of authorization system 100 associated with origin device 105. As another example, grant information 305 may include information indicating an origin country associated with origin device 105. For example, the origin country may be the country where the device is located.

Authorization pointer 307 may be configured to indicate a location of information associated with the transaction. In some embodiments, authorization pointer 307 may be configured to indicate a file, location, or resource external to the distributed data structure. For example, authorization pointer 307 may indicate all or part of a URL. In certain embodiments, authorization pointer 307 may be configured to indicate a transaction within the distributed data structure. For example, authorization pointer 307 may indicate a prior transaction containing all or part a message. This may enable message(s) 215 to be distributed across multiple transactions.

In some embodiments, central authorization system 101 may be configured to encrypt at least a portion of creation message 301. For example, central authorization system 101 may be configured to encrypt one or more of message type 303, grant information 305, and authorization pointer 307. Central authorization system 101 may be configured to use a stream cipher, such as Salsa20, for encryption. Central authorization system 101 may be configured to generate a key for encrypting creation message 301. In some aspects, this key may be generated from a seed using a key derivation function, such as bcrypt, according to methods known to one of skill in the art. One of skill in the art would appreciate that the envisioned systems and methods are not intended to be limited to a particular method of encryption.

In some embodiments, central authorization system 101 may be configured to generate perfection message 311 (FIG. 3B) in response to a request to perfect a grant of authorization. In certain aspects, perfection message 311 may be configured to contain one or more of message type 313, grant reference 315, and perfection code 317. In some aspects, message type 313 may indicate that the message corresponds to perfection of a grant of authorization. In some aspects, grant reference 315 may directly or indirectly indicate a message (e.g. one of message(s) 215) in distributed public data structure 111. For example grant reference 315 may be configured to contain a reference to a transaction id of a prior one of message(s) 215, such as a TXID for a bitcoin transaction. As an additional example, grant reference 315 may be configured to contain a reference to an external data structure. The external data structure may be configured to contain information relevant to perfection message 311. For example, the external data structure maybe configured to contain references identifying one or more relevant transactions, such as prior transactions in the distributed data structure. As an additional example, the external data structure maybe configured to contain one or more TXIDs for bitcoin transactions. In some embodiments, perfection message 311 may be configured to contain perfection code 317. In some embodiments, perfection code may be associated with the request to grant authorization. In certain aspects, perfection code 317 may be associated with the authorization request entries stored by database 103. As an additional example, database 103 may use perfection code 317 as an index or a key for one or more data elements storing the authorization request entries. In various aspects, perfection code 317 may be associated with a creation message such as creation message 301. For example, perfection code 317 may enable a user to decrypt creation message 301. In some aspects, perfection code 317 may be the key used to at least partially encrypt creation message 301. In various embodiments, perfection code 317 may be a seed used to generate the key used to at least partially encrypt creation message 301.

In some embodiments, central authorization system 101 may be configured to generate a transfer message. In some embodiments, transfer message 321 may be configured to contain one or more of message type 323, grant reference 325, and perfection code 327. In some aspects, message type 323 may indicate that the message corresponds to transfer of a grant of authorization. In some aspects, grant reference 325 may directly or indirectly indicate a message (e.g. one of message(s) 215) in distributed public data structure 111. For example grant reference 325 may be configured to contain a reference to a transaction id of a prior one of message(s) 215, such as a TXID for a bitcoin transaction. As an additional example, grant reference 315 may be configured to contain a reference to an external data structure. The external data structure may be configured to contain information relevant to perfection message 311. For example, the external data structure maybe configured to contain references identifying one or more relevant transactions, such as prior transactions in the distributed data structure. As an additional example, the external data structure maybe configured to contain one or more TXIDs for bitcoin transactions. In some embodiments, transfer message 321 may be configured to contain perfection code 327. In some embodiments, perfection code 327 may be associated with a request to grant authorization. In certain aspects, perfection code 327 may be associated with an authorization request entry stored by database 103. As an additional example, database 103 may use perfection code 327 as an index or a key for one or more data elements storing the authorization request entries. In various aspects, perfection code 327 may be associated with a creation message such as creation message 301. For example, perfection code 327 may enable a user to decrypt creation message 301. In some aspects, perfection code 327 may be a key used to at least partially encrypt creation message 301. In various embodiments, perfection code 327 may be a seed used to generate the key used to at least partially encrypt creation message 301. In certain aspects, perfection code 317 and perfection code 327 may be the same code.

In certain embodiments, transfer message 321 may be configured to contain one or more of second grant information 328 and second authorization pointer 329. In some aspects, second grant information 328 may describe the grant of authorization, and may describe conditions on the transfer of authorization similar to those described above with regard to grant information 305. In certain aspects, second grant information 328 may include information associated with origin device 105. For example second grant information 328 may include information describing the user of authorization system 100 associated with origin device 105. As another example, second grant information 328 may include information indicating an origin country associated with origin device 105. For example, the origin country may be the country where the device is located. Second authorization pointer 329 may be configured to indicate a location of information associated with the transaction. In some embodiments, second authorization pointer 329 may be configured to indicate a file, location, or resource external to the distributed data structure. For example, second authorization pointer 329 may indicate all or part of a URL. In certain embodiments, second authorization pointer 329 may be configured to indicate a transaction within the distributed data structure. For example, second authorization pointer 329 may indicate a prior transaction containing all or part a message. This may enable message(s) 215 to be distributed across multiple transactions.

In some embodiments, central authorization system 101 may be configured to encrypt at least part of transfer message 321. For example, central authorization system 101 may be configured to encrypt one or more of message type 323, grant reference 325, perfection code 327, second grant information 328, and second authorization pointer 329. Central authorization system 101 may be configured to use a stream cipher, such as Salsa20, for encryption. Central authorization system 101 may be configured to generate a key for encrypting creation message 321. In some aspects, this key may be generated from a seed using a key derivation function, such as bcrypt, according to methods known to one of skill in the art. One of skill in the art would appreciate that the envisioned systems and methods are not intended to be limited to a particular method of encryption.

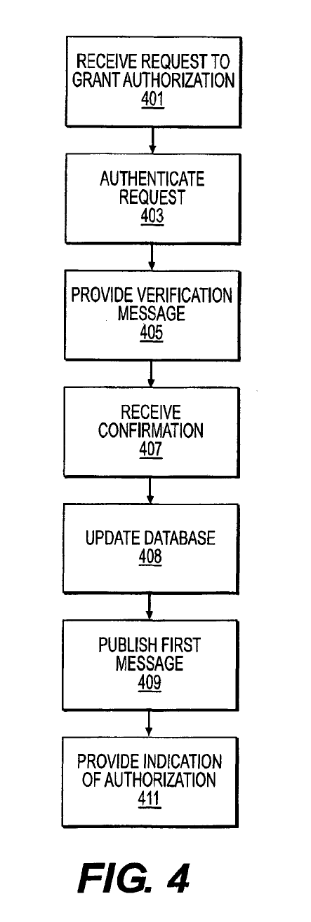

FIG. 4 depicts a flowchart of an exemplary method for creating a publicly verifiable grant of authorization, consistent with disclosed embodiments. In some embodiments, central authorization system 101 may be configured to receive a request to grant authorization in step 401. Central authorization system 101 may be configured to receive the request from origin device 105. In some aspects, origin device 105 may provide the request in response to indications received from a user. As described above with regard to FIG. 1, in some embodiments, the user may be first user 105a. First user 105a may have an account with central authorization system 101. Origin device 105 may be associated with first user 105a. In various embodiments, the user may be distinct from first user 105a. Origin device 105 may be configured to receive the indications from the user through a user interface. Central authorization system 101 may be configured to receive the request to grant authorization through an API exposed over network 115. The API may be an SMS API and the request may be an SMS message. The request may be conveyed through other protocols known to one of skill in the art, such as various high level protocols running on TCP/IP.

The request to grant authorization may comprise one or more of credentials, grant information, grantor information, and contact information, consistent with disclosed embodiments. In some aspects, the credentials may comprise information for identifying and authenticating one or more of origin device 105 and the user of the origin device. For example, the credentials may include a username and password. As a further example, the credentials may include a token, such as a token provided using one of numerous token-based authentication methods known to one of skill in the art. In some aspects, the credentials may include a first authorization record identifier. In some embodiments, the first authorization record identifier may correspond to an authorization record stored in database 103. In various embodiments, the credentials may include a perfection code corresponding to a previous grant of authorization. In some embodiments, the grant information may include grant information as described above with regards to creation message 301 (e.g., grant information 305). In some embodiments, the grantor information may include information describing the user of authorization system 100 associated with origin device 105. In some aspects, grantor information may include information indicating an origin country associated with origin device 105. For example, the origin country may be the country where the device is located.

In various embodiments the contact information may include contact information for second user 107a. For example, the contact information may comprise an email address, SIP address, phone number, instant message handle, or similar contact information for the second user 107a. In some aspects, the contact information may further include an identifier for the second user, such as a name or address. In some embodiments, the contact information may include contact information for first user 105a. For example, the contact information may comprise an email address, SIP address, phone number, instant message handle, or similar contact information for the first user 105a. Central authorization system 101 may be configured to request contact information for first user 105a, when first user 105a lacks an account with central authorization system 101.

Central authorization system 101 may be configured to authenticate the request for grant of authorization in step 403, consistent with disclosed embodiments. In some embodiments, central authorization system 101 may be configured to authenticate the request for grant of authorization based on the credential information. For example, in various embodiments, central authorization system 101 may be configured to authenticate the request for grant of authorization based on the first authorization record identifier. In certain aspects, central authorization system 101 may be configured to determine whether database 103 contains authorization records corresponding to the first authorization record identifier. Central authorization system may be configured to deny the request to grant authorization when no authorization record stored in database 103 corresponds to the first authorization record identifier. In certain aspects, central authorization system 101 may be configured to determine the sufficiency of the authorization record based on the grant information. Central authorization system may be configured to deny the request to grant authorization when the authorization record stored in database 103 does not contain sufficient rights to support the grant of authorization.

As a further example, in some embodiments, central authorization system 101 may be configured to authenticate the request for grant of authorization based on the perfection code corresponding to the previous grant of authorization. In some aspects, central authorization system may be configured to determine the sufficiency of the authorization request entry corresponding to the perfection code. Central authorization system may be configured to deny the request to grant authorization when the authorization request entry does not indicate sufficient rights to support the grant of authorization. In some aspects, central authorization system may be configured to determine the sufficiency of an authorization record corresponding to the perfection code using the corresponding authorization request entry. Central authorization system may be configured to deny the request to grant authorization when the corresponding authorization record does not indicate sufficient rights to support the grant of authorization.

Central authorization system 101 may be configured to provide a verification message in step 405, consistent with disclosed embodiments. In some aspects, the verification message may be provided to origin device 105. In some embodiments, the verification message may be provided to a device associated with first user 105a and distinct from origin device 105, according to the received contact information. In certain aspects, the verification message may indicate terms and conditions associated with the grant of authorization. In certain embodiments, central authorization system 101 may be configured to include a release token in the verification message.

Central authorization system 101 may be configured to receive a confirmation message in step 407, consistent with disclosed embodiments. In some embodiments, the confirmation message may be received from origin device 105. In various embodiments, the confirmation message maybe received from a device associated with first user 105a and distinct from origin device 105. In some embodiments, the confirmation message may indicate that the first user has agreed to the terms and conditions of the grant of authorization. In certain embodiments, the confirmation message may include the release token, and central authorization system 101 may be configured to create an authorization request entry in database 103 and perform steps 409 and 411 upon receipt and validation of the release token, according to methods known to one of skill in the art.

Central authorization system 101 may be configured to create an authorization request entry in step 408, consistent with disclosed embodiments. In some embodiments, central authorization system 101 may be configured to create this authorization request entry in database 103. In some aspects, this authorization request entry may comprise perfection code 317, the grantor information, and the grant information. As described above, perfection code 317 may comprise a seed for generating the cryptographic key used to decrypt a first message, described below. In certain embodiments, the perfection code 317 may comprise the cryptographic key used to decrypt the first message. The grant information may include a first authorization record identifier corresponding to the user associated with origin device 105. In some embodiments, when the grant of authorization is based upon the perfection code corresponding to the previous grant of authorization, central authorization system 101 may be configured to modify or delete the authorization request entry for the previous grant of authorization.

Central authorization system 101 may be configured to publish the first message in step 409, consistent with disclosed embodiments. As described above with respect to FIGS. 1 and 2, central authorization system 101 may be configured to publish the first message to processing nodes 109 for incorporation into distributed public data structure. In some embodiments, central authorization system 101 may be configured to package the first message in one or more dummy transactions. In some aspects, the first message may comprise creation message 301, as described with respect to FIG. 3A. For example, first message may be at least partially encrypted. By publishing first message, central authorization system 101 establishes an irrevocable record of the grant of authorization.

Central authorization system 101 may be configured to provide an indication of the grant of authorization to second user 107a in step 411, consistent with disclosed embodiments. In some embodiments, central authorization system 101 may be configured to provide the indication to a device associated with second user 107a. In certain aspects, the device may be distinct from destination device 107. Central authorization system 101 may be configured to provide the indication according to the contact information received from first user 105a in the request to transfer authorization. In some embodiments, the indication of the grant of authorization may include perfection code 317, as described above with regard to FIG. 3B. In certain aspects, perfection code 317 may enable second user 107a to decrypt the first message recorded in the distributed public data structure.

In some embodiments, central authorization system 101 may be configured to receive a request revoking the request to grant authorization. Central authorization system 101 may be configured to receive this request from origin device 105. Central authorization system 101 may be configured to receive this request from a device associated with first user 105a. In some embodiments, this request may be received before the user 107a has provided a request to prefect the grant of authorization. In certain embodiments, central authorization system 101 may be configured to determine that this request has occurred within a predetermined time period. Based on that determination, central authorization system 101 may be configured to reject future requests to perfect the grant of authorization. In some embodiments, the predetermined time period may be set in light of a regulatory requirement. In certain aspects, the predetermined time period may be between one minute and one hour. In some aspects, the predetermined time period may be between 15 minutes and 45 minutes. For example, the predetermined time period may be approximately 30 minutes. In certain aspects, central authorization system 101 may delay one or more of publishing the message to processing nodes 109 for incorporation into distributed public data structure 111 and providing an indication of the request to grant authorization to second user 107a until the predetermined time period has expired.

The sequence of steps disclosed above is not intended to be limiting. As would be recognized by one of skill in the art, the above-mentioned steps may be executed in an alternative order without departing from the contemplated embodiments. Similarly, steps may be added, omitted, combined, or divided without departing from the contemplated embodiments.

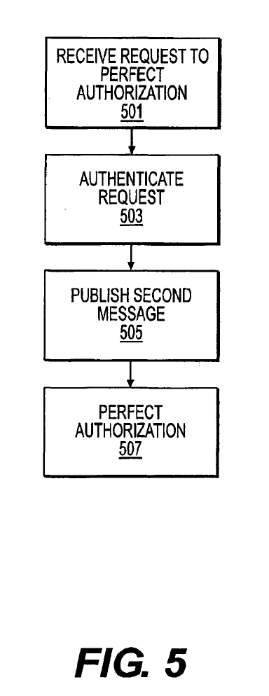

FIG. 5 depicts a flowchart of an exemplary method for publicly verifiable perfection of a grant of authorization, consistent with disclosed embodiments. Central authorization system 101 may be configured to receive a request to perfect a grant of authorization in step 501. In some embodiments, central authorization system 101 may be configured to receive the request from destination device 107. In some aspects, destination device 107 may provide the request in response to indications received from a user. As described above with regard to FIG. 1, in some embodiments, the user may be second user 107a. Second user 107a may have an account with central authorization system 101. Destination device 107 may be associated with second user 107a. In various embodiments, the user may be distinct from second user 107a. Destination device 107 may be configured to receive the indications from the user through a user interface. Central authorization system 101 may be configured to receive the request to perfect the grant of authorization through an API exposed over network 115. The API may be an SMS API and the request may be an SMS message. The request may be conveyed through other protocols known to one of skill in the art, such as various high level protocols running on TCP/IP, such as HTTP.

In some aspects, the request to perfect a grant of authorization may comprise one or more of credential information and perfection code 317. The credentials may comprise information for identifying and authenticating one or more of the destination device 107 and the user of the destination device. For example, the credentials may include a username and password. As a further example, the credentials may include a token, such as a token provided using one of numerous token-based authentication methods known to one of skill in the art. As an additional example, the credentials may include a second authorization record identifier. In some embodiments, this second authorization record identifier may correspond to an authorization record stored in database 103.

Central authorization system 101 may be configured to authenticate the request to perfect a grant of authorization in step 503, consistent with disclosed embodiments. In some embodiments, central authorization system 101 may be configured to authenticate the request to perfect a grant of authorization based on the credential information. In certain aspects, central authorization system 101 may be configured to determine whether database 103 contains an authorization record corresponding to the second authorization record identifier. Central authorization system may be configured to deny the request to grant authorization when no authorization record stored in database 103 corresponds to the second authorization record identifier. Central authorization system 101 may be configured to determine whether database 103 contains an authorization request entry corresponding to perfection code 317, consistent with disclosed embodiments. Central authorization system 101 may be configured to deny the request to perfect authorization when no authorization request entry corresponds to perfection code 317. In some aspects, central authorization system 101 may be configured to determine whether grant information of the authorization request entry comprises grant conditions. In certain aspects, central authorization system 101 may be configured to deny the request to perfect authorization when these grant conditions have not been satisfied, for example when the request to grant authorization has expired, or when only specific devices may provide the request to perfect the grant of authorization.

Central authorization system 101 may be configured to publish a second message in step 505, consistent with disclosed embodiments. As described above with respect to FIGS. 1 and 2, central authorization system 101 may be configured to publish the second message to processing nodes 109 for incorporation into distributed public data structure. In some embodiments, central authorization system 101 may be configured to package the second message in one or more dummy transactions. In some aspects, the second message may comprise perfection message 311, as described with respect to FIG. 3A. For example, second message may not be encrypted. In certain aspects, second message may contain perfection code 317. By publishing second message, central authorization system 101 enable public access to the first message that established the irrevocable record of the grant of authorization.

Central authorization system 101 may be configured to grant authorization according to the request to perfect a grant of authorization in step 507, consistent with disclosed embodiments. In some embodiments, central authorization system 101 may be configured to access database 103 to update authorization records. In certain aspects, central authorization system 101 may be configured to use the authorization request entry to update authorization records. For example, as described above, the authorization request entry may contain grant information and a first authorization record identifier, and the request to perfect the grant of authorization may include a second authorization record identifier. In certain aspects, central authorization system 101 may be configured to update the authorization records based on the first and second authorization record identifiers and the grant information.

The sequence of steps disclosed above is not intended to be limiting. As would be recognized by one of skill in the art, the above-mentioned steps may be executed in an alternative order without departing from the contemplated embodiments. Similarly, steps may be added, omitted, combined, or divided without departing from the contemplated embodiments.

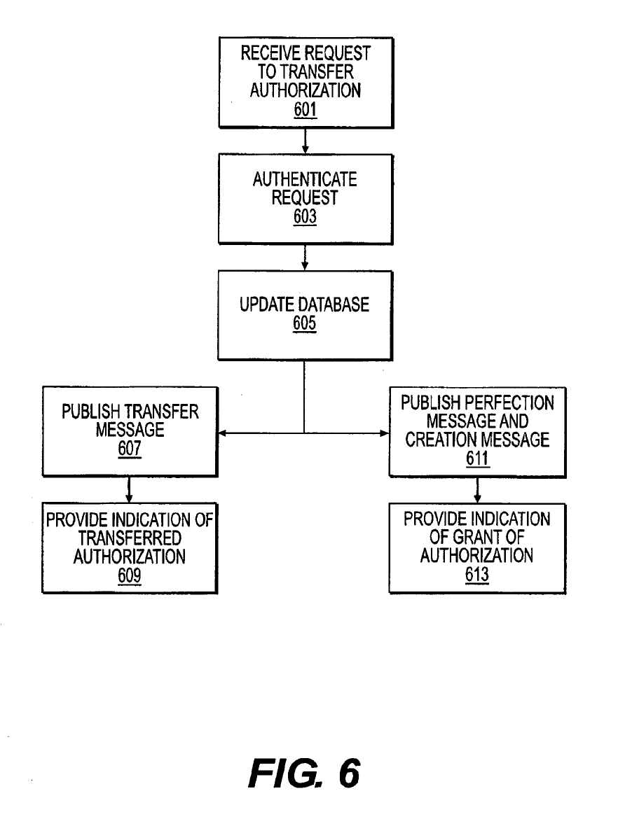

FIG. 6 depicts a flowchart of an exemplary method for publicly verifiable transfer of a grant of authorization, consistent with disclosed embodiments. Central authorization system 101 may be configured to receive a request to transfer a grant of authorization in step 601. In some embodiments, central authorization system 101 may be configured to receive the request from destination device 107. In some aspects, destination device 107 may provide the request in response to indications received from a user. As described above with regard to FIG. 1, in some embodiments, the user may be second user 107a. Destination device 107 may be associated with second user 107a. Destination device 107 may be configured to receive the indications from the user through a user interface. Central authorization system 101 may be configured to receive the request to transfer the grant of authorization through an API exposed over network 115. The API may be an SMS API and the request may be an SMS message. The request may be conveyed through other protocols known to one of skill in the art, such as various high level protocols running on TCP/IP, such as HTTP.

In some embodiments, the request to transfer a grant of authorization may comprise one or more of credentials, second grant information, second grantor information, second contact information, and perfection code 317. The credentials may comprise information for identifying and authenticating one or more of the destination device 107 and the user of the destination device. For example, the credentials may include a username and password. As a further example, the credentials may include a token, such as a token provided using one of numerous token-based authentication methods known to one of skill in the art. In some embodiments, the second grant information may include grant information as described above with regards to transfer message 321 (e.g., second grant information 328). In some aspects, the second grantor information may include information describing the user of authorization system 100 associated with destination device 107. In some aspects, second grant information may include information indicating a country associated with destination device 107. For example, the country may be the country where destination device 107 is located.

In various embodiments the second contact information may include contact information for another user. For example, the second contact information may comprise an email address, SIP address, phone number, instant message handle, or similar contact information for the other user. In some aspects, the second contact information may further include an identifier for the other user, such as a name or address. In some embodiments, the contact information may include contact information for second user 107a. For example, the contact information may comprise an email address, SIP address, phone number, instant message handle, or similar contact information for second user 107a. Central authorization system 101 may be configured to request contact information for second user 107a, when second user 107a lacks an account with central authorization system 101.

Central authorization system 101 may be configured to authenticate the request for grant of authorization in step 603, consistent with disclosed embodiments. In some embodiments, central authorization system 101 may be configured to authenticate the request for grant of authorization based on the credential information. In certain aspects, central authorization system 101 may be configured to determine whether database 103 contains authorization records corresponding to the first authorization record identifier. Central authorization system may be configured to deny the request to transfer authorization when no authorization record stored in database 103 corresponds to the first authorization record identifier. In certain aspects, central authorization system 101 may be configured to determine the sufficiency of the authorization record based on the grant information. Central authorization system 101 may be configured to determine whether database 103 contains an authorization request entry corresponding to perfection code 317, consistent with disclosed embodiments. Central authorization system 101 may be configured to deny the request to perfect authorization when no authorization request entry corresponds to perfection code 317. In some aspects, central authorization system 101 may be configured to determine whether grant information of the authorization request entry comprises grant conditions. In certain aspects, central authorization system 101 may be configured to deny the request to transfer authorization when these grant conditions have not been satisfied, for example when the request to grant authorization has expired, or when only specific devices may provide the request to transfer the grant of authorization.

Central authorization system 101 may be configured to update database 103 in step 605, consistent with disclosed embodiments. In some embodiments, central authorization system 101 may be configured to access database 103 to update authorization records. In certain aspects, central authorization system 101 may be configured to alter the authorization request entry corresponding to perfection code 317. For example, the updated authorization request entry may include the grant information received in the request to transfer a grant of authorization (e.g., second grant information 328). In some aspects, central authorization system 101 may be configured to replace perfection code 317 with a new code, such as perfection code 327. As an additional example, central authorization system 101 may be configured to replace the authorization request entry corresponding to perfection code 317 with a new authorization request entry corresponding to a new code, such as perfection code 327. The new authorization request entry may include the grant information received in the request to transfer a grant of authorization (e.g., second grant information 328).

Central authorization system 101 may be configured to publish a second message in step 607, consistent with disclosed embodiments. As described above with respect to FIGS. 1 and 2, central authorization system 101 may be configured to publish a second message to processing nodes 109 for incorporation into distributed public data structure 111. In some embodiments, central authorization system 101 may be configured to package the second message in one or more dummy transactions. In some aspects, the second message may comprise transfer message 321, as described with respect to FIG. 3C. For example, the second message may be encrypted. In various aspects, the second message may contain one or more of perfection code 327, grant reference 325, and second grant information 328. By publishing second message, central authorization system 101 may establish an irrevocable record of the transfer of the grant of authorization.

Central authorization system 101 may be configured to provide an indication of the transfer of authorization by second user 107a in step 609, consistent with disclosed embodiments. In some embodiments, central authorization system 101 may be configured to provide the indication to a device associated with the other user. Central authorization system 101 may be configured to provide the indication according to the contact information received from second user 107a in the request to transfer the grant of authorization. In some embodiments, the indication of the transfer of grant of authorization may include perfection code 327. In certain aspects, this second perfection code may enable the other user to decrypt transfer message 321 recorded in distributed public data structure 111. The perfection code 327, stored in the transfer message, may enable second user 107a to decrypt creation message 301 stored in the distributed public database.

Central authorization system 101 may be configured to publish a second message and a third message in step 611, consistent with disclosed embodiments. Central authorization system 101 may be configured to publish the second message and third message to processing nodes 109 for incorporation into distributed public data structure 111. In some embodiments, central authorization system 101 may be configured to package the second message and the third message in two or more dummy transactions. In some aspects, the second message may comprise a perfection message 311 corresponding to the first message (e.g. creation message 301). For example, the second message may not be encrypted. In various aspects, the second message may contain one or more of perfection code 317 and grant reference 315. In certain aspects, the third message may comprise a second creation message. The third message may be at least partially encrypted. A key for decrypting the third message may be associated with the new code generated in step 605. For example, as discussed above, the key may be derived from the new code. In various aspects, the third message may contain second grant information. In some embodiments second grant information may different from grant information 305.

Central authorization system 101 may be configured to provide an indication of the second grant of authorization to the other user in step 611, consistent with disclosed embodiments. In some embodiments, central authorization system 101 may be configured to provide the indication to a device associated with the other user. In certain aspects, the device may be destination device 107. Central authorization system 101 may be configured to provide the indication according to the contact information received from second user 107a in the request to transfer authorization. In some embodiments, the indication of the second grant of authorization may include a second perfection code. In certain aspects, the second perfection code may enable the other user to decrypt the second creation message recorded in the distributed public data structure.

The sequence of steps disclosed above is not intended to be limiting. As would be recognized by one of skill in the art, the above-mentioned steps may be executed in an alternative order without departing from the contemplated embodiments. Similarly, steps may be added, omitted, combined, or divided without departing from the contemplated embodiments.

Though described with respect to single codes and single recipients, the envisioned methods of transferring grants of authorization may be generalized to any number of transferor grants of authorization and transferee grants of authorization. For example, central authorization system 101 may be configured to receive a request to transfer a grant of authorization to multiple other users. Central authorization system 101 may be configured to receive, in part, grant information and contact information corresponding to each of the other users. Central authorization system 101 may be configured to access database 103 (as in step 605) to update the authorization records with authorization request entries corresponding to each of the other users. Central authorization system 101 may be configured to publish transfer messages and provide indications of transferred authorizations, as in steps 607 and 609, and/or publish perfections messages and creation messages and provide indications of granted authorizations, as in steps 611 and 613.

As another example, central authorization system 101 may be configured to receive a request to transfer multiple grants of authorization to another user. Central authorization system 101 may be configured to access database 103 (as in step 605) to update the authorization records with an authorization request entry corresponding to the other user. Central authorization system 101 may be configured to publish a transfer message and provide an indication of the transferred authorization, as in steps 607 and 609, and/or publish a perfection message and creation message and provide an indication of a grant of authorization, as in steps 611 and 613.

As a further example, central authorization system 101 may be configured to receive a request to transfer a portion of a grant of authorization to another user. Central authorization system 101 may be configured to access database 103 (as in 605) to update authorization records, modifying the original authorization request entry to reflect the partial transfer, and creating a new authorization request entry corresponding to the other user. Central authorization system 101 may be configured to publish transfer messages and provide indications of transferred authorizations, as in steps 607 and 609, and/or publish perfections messages and creation messages and provide indications of granted authorizations, as in steps 611 and 613.

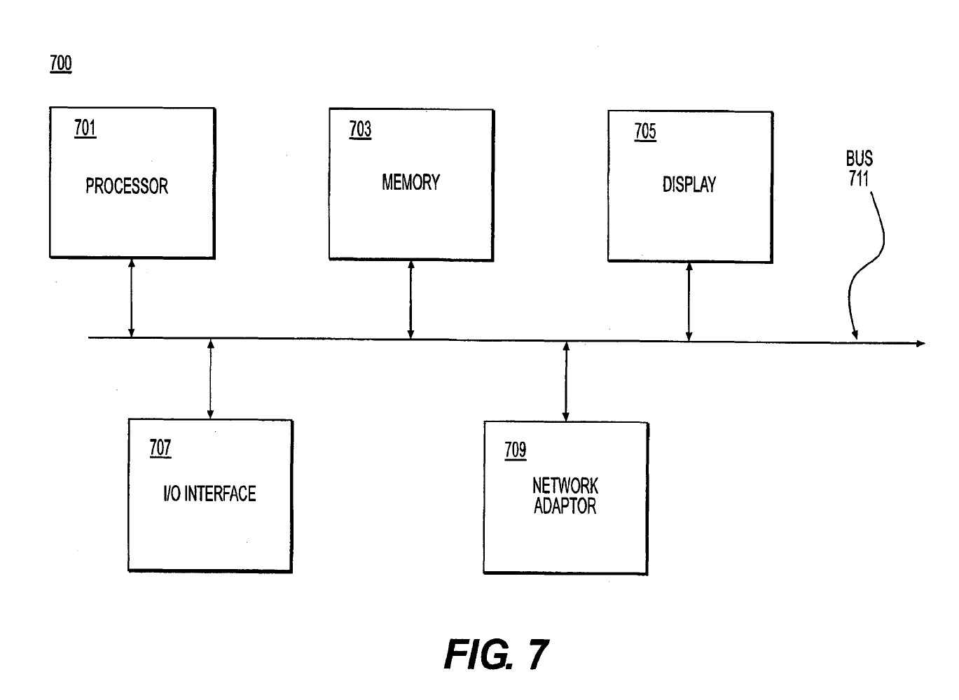

FIG. 7 depicts an exemplary computing system for publicly verifiable authorization. In some embodiments, computer system 700 includes a processor 701, memory 703, display 705, I/O interface(s) 707, and network adapter 709. These units may communicate with each other via bus 711, or wirelessly. The components shown in FIG. 7 may reside in a single device or multiple devices.

Consistent with disclosed embodiments, processor 701 may be a microprocessor or a central processing unit (CPU). Memory 703 may include non-transitory memory containing non-transitory instructions, such as a computer hard disk, random access memory (RAM), removable storage, or remote computer storage. In some aspects, memory 703 may be configured to store software programs. In some aspects, processor 701 may be configured to execute non-transitory instructions and/or programs stored on memory 703 to configure computer system 700 to perform operations of the disclosed systems and methods. In various aspects, as would be recognized by one of skill in the art, processor 701 may be configured to execute non-transitory instructions and/or programs stored on a remote memory to perform operations of the disclosed systems and methods. Display 705 may be any device which provides a visual output, for example, a computer monitor, an LCD screen, etc. I/O interfaces 707 may include means for communicating information to computer system 700 from a user of computer system 700, such as a keyboard, mouse, trackball, audio input device, touch screen, infrared input interface, or similar device. Network adapter 709 may enable computing system 700 to exchange information with external networks. For example, network adapter 709 may include a wireless wide area network (WWAN) adapter, a Bluetooth module, a near field communication module, or a local area network (LAN) adapter.

The following exemplary applications of the disclosed systems and methods are provided to illustrate the breadth and general applicability of the envisioned systems and methods for publically verifiable authorization. These illustrative examples depend from and further describe the systems and methods disclosed above. Thus these illustrative examples incorporate the structures and functions generally disclosed above with regards to FIG. 1 to FIG. 7. Furthermore, the claimed subject matter is not limited to these illustrative examples, but instead defined by the appended claims in light of their full scope of equivalents.

### Example 1: Collaboration and Content Access Control

In the manner described above with regards to FIG. 1, authorization system 100 may be configured to manage authorization for registered users of authorization system 100 (e.g., users that have created accounts with authorization system 100). In some aspects, these authorizations may be content access rights. For example, first user 105a may desire to grant or transfer content access rights for a content item to second user 107a. To effectuate this grant or transfer of content access rights in a publicly verifiable manner, first user 105a may interact with authorization system 100 to grant or transfer the content access rights to second user 107a. In such embodiments, authorization records, in the manner described above, may comprise records of content access rights. Similarly, grants of authorization, in the manner described above, may comprise grants of content access rights.

In some embodiments, database 103 may be arranged and configured to manage content access rights for users of authorization system 100. For example, database 103 may comprise content access rights corresponding to a user associated with origin device 105. For example, the user associated with origin device 105 may own the content, be responsible for maintaining the content, or otherwise have at least partial control over access to the content. In some embodiments, the user associated with origin device 105 may be first user 105a. In certain embodiments, first user 105a may interact with another user (e.g., a parent or guardian, not shown) to access authorization system 100 to grant content access rights. As an additional example, the user associated with destination device 107 may own the content, be responsible for maintaining the content, or otherwise have at least partial control over access to the content. In some embodiments, the user associated with destination device 107 may be second user 107a. In certain embodiments, second user 107a may interact with another user (e.g. a parent or guardian, not shown) to use authorization system 100 to perfect grants of content access rights. In this manner, authorization system 100 may be configured to enable collaborative and/or exclusive access to the content between, as a non-limiting example, first user 105a and second user 107a.

In certain embodiments, the content access rights managed by central authorization system 101 may pertain to digital holdings of account holder system 113. In some embodiments, a content repository (not shown) may be associated with account holder system 113. For example, a cloud storage repository may be associated with account holder system 113. The holdings of account holder system 113 may comprise collections of content items, such as digital multimedia libraries, documents, presentations, spreadsheets, applications, data, or other content items known to one of skill in the art.

In some embodiments, account holder system 113 may be configured to conduct transactions with users of authorization system 100 that modify the contents of the at least one account associated with central authorization system 101. In some aspects, these transactions may occur directly between account holder system 113 and the users of authorization system 100. For example, client applications or front ends may facilitate interactions between users of authorization system 100 and the holdings of account holder system 113. These client applications or front ends may be configured to use the message documenting the grant of rights incorporated into distributed public data structure 111. For example, the client applications or front ends may be configured to impose policies on access to the holdings of account holder system 113 by users of authorization system 100 according to the incorporated messages. In some embodiments, the client applications or front ends may be may be adapted to the type of content holding (e.g., multimedia players, document editing software). In various aspects, these transactions may occur indirectly between account holder system 113 and the users of authorization system 100. For example, these transactions may use central authorization system 101, or another system, as an intermediary.

In some embodiments, central authorization system 101 may be configured to access database 103 to respectively modify content access rights information associated with users of authorization system 100, when these users conduct transactions with account holder system 113. For example, a user of authorization system 100 may add or remove content items from the at least one account associated with central authorization system 101. In response, central authorization system 101 may be configured to access database 103 to enable or disable the ability to grant content access rights for the added or removed content items.

In the manner described above with regards to FIG. 3, grant information 305 may describe a grant of rights, consistent with disclosed embodiments. In some aspects, the rights may concern content access rights and the grant of rights may effectuate a transfer of content access rights. In some aspects, grant information 305 may describe one or more content items and content access rights. For example, a content item may be a multimedia file, Word document, PowerPoint presentation, Excel file, or a similar content item. As an additional example, the content access rights may be at least one of reading, writing, and deleting. In some embodiments, the content access rights may be exclusive between users of authorization system 100. For example, central authorization system 101 may be configured to access database 103 to remove or suspend access rights of first user 105a and add or activate corresponding access rights for second user 107a. In some embodiments, a reciprocal grant of rights requirement may comprise a requirement to transfer content access rights within a certain time to a certain destination. For example, second user 107a may be required to return the content access rights to first user 105a, or provide the rights to another party. This reciprocal grant of rights may include time limitations. In some aspects, central authorization system 101 may be configured to require the transfer of access rights be exclusive. For example, where the content item is a multimedia file, central authorization system 101 may be configured to require that either first user 105a or second user 107a have content access rights, but not both.

In certain embodiments, transfer message 321 may be configured to contain one or more of second grant information 328 and second authorization pointer 329. In some aspects, second grant information 328 may describe the grant of rights. In some aspects, the rights may concern content access rights and the grant of rights may effectuate a transfer of content access rights. In some aspects, second grant information 328 may describe one or more content items and content access rights. In some aspects, central authorization system 101 may be configured to require the transfer of access rights be exclusive. For example, where the content item is a multimedia file, central authorization system 101 may be configured to require that either first user 105a or second user 107a have content access rights, but not both.

In the manner described above with regards to FIG. 4, central authorization system 101 may be configured to receive a request to grant rights in step 401. In some aspects, origin device 105 may provide the request in response to indications received from a user. In some aspects, the user may be providing a request for content access rights in exchange for a reciprocal grant of content access rights. In some embodiments, the grant information, in the manner described above with regard to FIGS. 3A-3C, may concern content access rights. For example, the content access rights may concern one or more multimedia files, or similar content items. As an additional example, the content access rights may be playing the multimedia file. In some aspects, the reciprocal grant of access rights may comprise the grant of limited content access rights to the one or more multimedia files, or similar content items. These rights may be limited in time, video quality, or number of plays, as would be appreciated by one of skill in the art.

In some embodiments, central authorization system 101 may be configured to authenticate the request for authorization in step 403, consistent with disclosed embodiments. In certain aspects, central authorization system 101 may be configured to determine the sufficiency of the authorization records based on the grant information. For example, central authorization system 101 may be configured to deny the request to grant rights when no rights concerning the content item are associated with the authorization records. In some embodiments, central authorization system 101 may be configured to determine the sufficiency of the grant of rights associated with the code. For example, central authorization system 101 may be configured to deny the request to grant rights when the grant request indicates a greater degree of rights than associated with the code. In some aspects, central authorization system 101 may be configured to deny a request for a non-exclusive transfer of content access rights. In other aspects, central authorization system 101 may be configured to deny a request for an exclusive transfer of content access rights.

In some embodiments, central authorization system 101 may be configured to provide a verification message in step 405, consistent with disclosed embodiments. In certain aspects, the verification message may indicate terms and conditions associated with the grant of rights. For example, in response to a request to grant rights, central authorization system 101 may be configured to indicate in the verification message the degree and duration of the transfer of content access rights. In some aspects, the verification message may also indicate the effect of the transfer on the rights of transferor. In various aspects, the verification message may indicate whether third parties may receive content access rights as part of the transfer. For example, a user with an account with central authorization system 101 (e.g. a parent or guardian) may require limited content access rights in exchange the request to grant rights. As an additional example, a second user having an account with central authorization system 101 (e.g., a parent or guardian) may require limited content access rights in exchange for perfecting the grant of rights. In some embodiments, central authorization system 101 may be configured to indicate an expiration time in the verification message. In certain embodiments, the central authorization system may be configured to include an authorization token in the verification message.

In the manner described above with regards to FIG. 5, central authorization system 101 may be configured to receive a request to perfect a grant of rights in step 501. In some aspects, destination device 107 may provide the request in response to indications received from a user. The user may be providing a request to perfect a grant of rights in exchange for limited content access rights.

In this manner, the disclosed embodiments may be used to enable collaborative and/or exclusive access to content items (e.g. documents, presentations, spreadsheets, multimedia files, or similar content items) stored an account holder system (e.g., account holder system 113). Users may access the stored content items using client systems that impose policies based on publically available, non-revocable messages published to a distributed database. Account holders, such as parents or guardians, may monitor the usage of the distributed rights systems by requiring access to content items in exchange for granting or perfecting rights.

### Example 2: Financial Applications

In the manner described above with regards to FIG. 1, authorization system 100 may be configured to manage authorizations for registered users of authorization system 100 (e.g., users that have created accounts with authorization system 100). In some aspects, these authorizations may concern funds, financial instruments, or similar stores of value (referred to herein as “funds”). For example, first user 105a may desire to transfer funds to second user 107a. To effectuate this transfer of funds in a publicly verifiable manner, first user 105a may interact with authorization system 100 to transfer the funds to second user 107a. In such embodiments, authorization records, in the manner described above, may comprise financial records. Similarly, grants of authorization, in the manner described above, may comprise payments, loans, or other transfers of funds.

In some embodiments, database 103 may be arranged and configured to store financial records for users of authorization system 100. For example, database 103 may comprise a financial account corresponding to a user associated with origin device 105. As an additional example, database 103 may comprise a financial account corresponding to a user associated with destination device 107. In the manner described above with regards to FIG. 1, these financial accounts may indicate available funds for users of authorization system 100. For example, an account balance may indicate a quantity of funds available to a user of authorization system 100. As an additional example, database 103 may comprise a digital ledger tracking account information for users of authorization system 100. In certain aspects, database 103 may be configured to store entries corresponding to requests to transfer funds. In some aspects, such entries may comprise keys, grantor information, and grant information. Grant information may indicate the extent and characteristics of any transfer of funds. For example, the grant information may indicate one or more of the amount and target denomination (e.g., Euros and the like) of the transfer of funds.

In certain embodiments, first user 105a may interact with another user (not shown) to access authorization system 100 to transfer funds. In certain aspects, this user may transfer funds to second user 107a in exchange for compensation from first user 105a. In various aspects, such compensation may be incorporated into the transfer of funds from first user 105a to second user 107a.

In certain embodiments, second user 107a may interact with another user (not shown) to use authorization system 100 to transfer funds. In certain aspects, this user may perfect a transfer of funds by first user 105a in exchange for compensation from one or more of first user 105a and second user 107a. In various aspects, such compensation may be incorporated into the transfer of funds from first user 105a to second user 107a.

In certain embodiments, account holder system 113 may be configured to store the funds managed by central authorization system 101. In some embodiments, a financial institution (not shown) may be associated with account holder system 113. For example, a money services business may be associated with account holder system 113. In some aspects, the accounts held by account holder system 113 may comprise financial services accounts.

In some embodiments, account holder system 113 may be configured to conduct transactions with users of authorization system 100. In some aspects, these transaction may modify the contents of the at least one account associated with central authorization system 101. In some aspects, these transactions may occur directly between account holder system 113 and the users of authorization system 100. In various aspects, these transactions may occur indirectly between account holder system 113 and the users of authorization system 100. For example, these transactions may use central authorization system 101, or another system, as an intermediary. In some embodiments, central authorization system 101 may be configured to access database 103 to modify financial records associated with users of authorization system 100, when these users conduct transactions with account holder system 113. For example, a user of authorization system 100 may add or withdraw funds from the at least one account associated with central authorization system 101. In response, central authorization system 101 may be configured to access database 103 to respectively increment or decrement financial records associated with the user.

In the manner described above with regards to FIG. 3, grant information 305 may describe a transfer of funds, consistent with disclosed embodiments. In some aspects, grant information 305 may describe one or more of an amount of funds and target denomination (e.g. Euros). For example, a reciprocal grant of rights requirement may comprise a requirement to transfer funds to a certain destination. As an additional example, the reciprocal grant of rights requirement may impose time requirements on the required transfer of funds. In some aspects, central authorization system 101 may be configured to require the amount of funds to be less than a threshold amount.

In certain embodiments, transfer message 321 may be configured to contain one or more of second grant information 328 and second authorization pointer 329. In some aspects, second grant information 328 may describe a transfer of funds. In some aspects, second grant information 328 may describe one or more of an amount of funds and target denomination (e.g. Euros). Central authorization system 101 may be configured to require the amount of funds to be less than a threshold amount.

In the manner described above with regards to FIG. 4, central authorization system 101 may be configured to receive a request to transfer funds in step 401. In some aspects, origin device 105 may provide the request in response to indications received from a user. In some aspects, the user may be providing the request to transfer funds in exchange for compensation from first user 105a. For example, the user may be acting as a broker. In some embodiments, the grant information, in the manner described above with regard to FIGS. 3A-3C, may concern the transfer of funds. In certain aspects, the grant information may indicate the amount of funds to be transferred. This amount may comprise either an origination amount provided by the first user 105a or a destination amount received by the second user 107a. The grant information may describe a target denomination (e.g. Euros) of the funds. For example, the grant information may indicate a target amount expressed in a target denomination.

In some embodiments, central authorization system 101 may be configured to authenticate the request for authorization in step 403, consistent with disclosed embodiments. In certain aspects, central authorization system 101 may be configured to determine the sufficiency of the authorization records based on the grant information. For example, when rights correspond to funds, central authorization system 101 may be configured to deny the request to transfer funds when the grant request indicates a greater amount of funds than the balance of the authorization records.

In some embodiments, central authorization system 101 may be configured to determine the sufficiency of an authorization request entry associated with a perfection code (e.g. perfection code 317). For example, central authorization system 101 may be configured to deny the request to transfer funds when the request to transfer funds indicates a greater amount of funds than the balance of the authorization request entry associated with the perfection code. In some aspects, central authorization system 101 may be configured to deny a request to grant rights exceeding a threshold amount. In some aspects, central authorization system 101 may be configured to deny a request to grant rights below a threshold amount.

In some embodiments, central authorization system 101 may be configured to provide a verification message in step 405, consistent with disclosed embodiments. In certain aspects, the verification message may indicate terms and conditions associated with the grant of rights. For example, in response to a request to grant rights, central authorization system 101 may be configured to indicate in the verification message fees associated with the grant of rights. For example, such fees may include one or more of origination fees, perfection fees, and central authorization system fees. For example, a first broker having an account with central authorization system 101 may charge first user 105a a fee to generate the request to grant rights. As an additional example, a second broker having an account with central authorization system 101 may charge second user 107a a fee to perfect the request to grant rights. As a further example central authorization system 101 may be configured to deduct a fee from the transferred amount. In some embodiments, first user 105a and second user 107a may have accounts with central authorization system 101. In such embodiments, only central authorization system would be assessed. In some aspects, the first broker may initiate the request to grant rights in a first currency distinct from a target currency specified in the grant information. In such aspects, central authorization system 101 may be configured to provide an exchange rate for conversion from the first currency to the target currency in the exchange message. In some embodiments, central authorization system 101 may be configured to indicate an expiration time in the verification message. In certain embodiments, the central authorization system may be configured to include an authorization token in the verification message.

In the manner described above with regards to FIG. 5, central authorization system 101 may be configured to receive a request to perfect a grant of rights in step 501. In some aspects, destination device 107 may provide the request in response to indications received from a user. The user may be providing a request to perfect a grant of rights in exchange for compensation from second user 107a. For example, the user may be acting as a broker.

In this manner, the disclosed embodiments may be used to financial services applications using a financial services account stored by an account holder system (e.g., account holder system 113). Users of authorization system 100 may interact with the financial services account using authorization system 100. As described below in non-limiting Example 2A, users of authorization system 100 may interact with authorization system 100 to transfer money. As described below in non-limiting Example 2B, users of authorization system 100 may interact with authorization system 100 to make or obtain publically verifiable loans. As described below in non-limiting Example 2C, users of authorization system 100 may interact with authorization system 100 to purchase additional cellular data/minutes/sms credits for a cellular account. As described below in non-limiting Example 2D, users of authorization system 100 may interact with authorization system 100 to payment for goods and/or services. As described below in non-limiting Example 2E, users of authorization system 100 may interact with authorization system 100 to manage money in a financial account. As described below in non-limiting Example 2F, users of authorization system 100 may interact with authorization system 100 to enable automatic loan payment collection.

### Example 2A: Money Transfer

As a specific example, first user 105a may use the envisioned embodiments to transfer money to second user 107a. First user 105a may provide funds in first currency (e.g., dollars), and second user 107a may funds in a second currency (e.g. pesos). First user 105a may contact an origination broker to originate the transfer of funds. The origination broker may have a pre-existing account with authorization system 100. The origination broker may have provisioned the account with funds, by transferring dollars to account holder system 113. Database 103 may store authorization records for the origination broker indicating the dollars transferred to account holder system 113.

Consistent with disclosed embodiments, the origination broker or first user 105a may use origin device 105 to provide a message requesting a transfer of funds. The request may indicate an amount of dollars to send, or an amount of pesos to be received. The request may indicate contact information for second user 107a. Central authorization system may authenticate the request and provide a verification message. The verification message may indicate the amount of pesos received based on the amount of dollars provided, or the amount of dollars that must be provided based on the amount of pesos to be received. The verification message may indicate fees assessed by one or more of the origination broker, central authorization system 101, and a destination broker. The verification message may indicate an exchange rate. The exchange rate may be favorable to central authorization system 101, thereby implementing a fee for central authorization system 101. The origination broker or first user 105a may use origin device 105 to provide a message confirming the transfer of funds.

Consistent with disclosed embodiments, central authorization system 101 may be configured to provide a message to second user 107a indicating the transfer of funds. This message may include perfection code 317. Central authorization system 101 may be configured to publish to processing nodes 109 an at least partially encrypted creation message (e.g. creation message 301) indicating the amount of pesos transferred to second user 107a.

Consistent with disclosed embodiments, following receipt of the message indicating the transfer of funds, second user 107a may contact a destination broker to perfect the transfer of funds. The destination broker may have an account with authorization system 100. The destination broker may have provisioned the account with funds, by transferring pesos to account holder system 113. Database 103 may store authorization records for the destination broker indicating the pesos transferred to account holder system 113.

Consistent with disclosed embodiments, the destination broker or second user 107a may use destination device 107 to provide a message requesting perfection of the transfer of funds. Following authentication of the request, central authorization system 101 may be configured to update records for origination broker and destination broker based on the grant request. In some aspects, the account of destination broker may be credited by at least the amount of pesos transferred to second user 107a. In certain aspects, the account of origination broker may be debited by at most the amount of dollar transferred from first user 105a. In certain aspects, the credit and the debit may reflect any fees due to one or more of origination broker, destination broker, and central authorization system 101. Central authorization system 101 may be configured to publish to processing nodes 109 an unencrypted perfection message (e.g., perfection message 311) indicating that second user 107a has received the pesos transferred from first user 105a. This perfection message may include perfection code 317 enabling decryption of the creation message. The destination broker may provide pesos in the transferred amount to second user 107a. For example, destination broker may provide pesos in cash to second user 107a.

Consistent with disclosed embodiments, origin device 105 and destination device 107 may be configured to interact with central authorization system 101 using an application, or “app,” configured for interacting with central authorization system 101.

### Example 2B: Publicly Verifiable Loan

Consistent with disclosed embodiments, first user 105a may use the envisioned embodiments to loan money to second user 107a. As in example 1, first user 105a may interact with an origination broker to transfer pesos to second user 107a. But the grant of rights provided by first user 105a may include a condition requiring a reciprocal grant of rights from second user 107a. In certain aspects, this reciprocal grant of rights may specify a repayment amount and a repayment time. Central authorization system 101 may be configured to publish a creation message (e.g., creation message 301) including information specifying the terms of the reciprocal grant of rights. Central authorization system 101 may be configured to publish a perfection message (e.g., perfection message 311) once second user 107a perfects the transfer of funds. By enabling decryption of the creation message, the perfection message may enable public verification of the terms of the loan. In some embodiments, second user 107a may request a second grant of rights transferring dollars to first user 105a according to the terms of the loan. In some aspects, this second grant of rights may indicate the relationship between this second transfer of funds from second user 107a to first user 105a and the initial transfer of funds from first user 105a to second user 107a. For example, this second grant of rights may indicate satisfaction of the original loan in whole or in part. Central authorization system 101 may be configured to publish messages (e.g., creation message 301 and perfection message 311) that enable public verification of the satisfaction of the original loan in whole or in part. In some embodiments, should second user 107a fail to meet the conditions on the first grant of rights, central authorization system 101 may be configured to publish an unencrypted message indicating this failure. In some embodiments, central authorization system 101 may be configured to generate and maintain a rating for second user 107a. This rating may depend on whether second user 107a satisfies the terms of the loan. Central authorization system 101 may provide this rating to entities considering extending credit to second user 107a.

### Example 2C: Cellular Recharge

Consistent with disclosed embodiments, first user 105a may use the envisioned embodiments to purchase additional cellular data/minutes/sms credits for a cellular account. In some aspects, this cellular account may belong to the first user 105a. In other aspects, this cellular account may belong to another user. First user 105a may have a pre-existing account with authorization system 100. First user 105a may have provisioned the cellular account with funds, by transferring dollars to account holder system 113. Database 103 may store an authorization record for first user 105a indicating the dollars transferred to account holder system 113.

Consistent with disclosed embodiments, first user 105a may use origin device 105 to provide a message requesting purchase of the additional cellular data/minutes/sms credits for the cellular account. In some aspects, the request may indicate an purchase amount and/or an amount of additional data/minutes/sms credits to be received. In certain aspects, the request may indicate that the data/minutes/sms credits for the cellular account be recharged.

Central authorization system 101 may authenticate the request and provide a verification message. The verification message may indicate the amount of additional data/minutes/sms credits to be purchased based on purchase amount, or the necessary purchase amount based on the additional data/minutes/sms credits to be purchased. The verification message may indicate fees assessed by one or more of the central authorization system 101 and the provider of the cellular account. In response, first user 105a may use origin device 105 to provide a message confirming the purchase of the additional data/minutes/sms credits.

Consistent with disclosed embodiments, rights holder system 117 may be associated with a cellular service provider of the cellular account. Rights holder system 117 may be configured to manage the cellular account. In some embodiments, central authorization system 101 may be configured to communicate with rights holder system 117 indicating the purchase of data/minutes/sms credits. Central authorization system 101 may be configured to direct rights holder system 117 to modify at least one parameter of the cellular account. The at least one parameter may include at least one of an account balance, minute balance, data balance, total minutes, total data usage, cellular plan type, or similar cellular service plan parameter. As a non-limiting example, central authorization system 101 may be configured to direct rights holder system 117 to recharge data/minutes/sms credits in the cellular account. Such direction may occur within a day, an hour, a minute, or in real-time, as would be appreciated by one of skill in the art. In this manner, a user may interact with the disclosed systems and methods to purchase additional cellular data/minutes/sms credits for the cellular account.

Consistent with disclosed embodiments, central authorization system 101 may also be configured to access database 103 to update rights information associated with first user 105a. For example, central authorization system 101 may also be configured to access database 103 to decrement a balance for the account of the first user 105a. The balance may be decremented by the total cost of the additional data/minutes/sms credits. Such updating may occur within a day, an hour, a minute, or in real-time, as would be appreciated by one of skill in the art.

Consistent with disclosed embodiments, central authorization system 101 may be configured to also direct account holder system 113 to transfer funds associated with first user 105a to the cellular service provider. As a non-limiting example, central authorization system 101 may direct account holder system 113 to initiate an automated clearing house transaction between account holder system 113 and a financial institution associated with the cellular service provider. In certain aspects, such automated clearing house transactions may be bundled into larger transactions that may be executed periodically. For example, each day's outstanding transactions may be bundled into a single, larger transaction for daily execution. One of skill in the art would recognize that such bundling may occur over a variety of time periods and that the above example is not intended to be limiting.

Consistent with disclosed embodiments, central authorization system 101 may also be configured to publish a first message to processing nodes 109 for incorporation into distributed public data structure 111. The first message may be a creation message, in the manner described above with regards to FIGS. 3A and 4. For example, grant information 305 may indicate at least one of the cellular service provider, the cellular account information, the modification to the at least one parameter, an order time or date, and other information related to the purchase of the additional data/minutes/sms credits.

In some embodiments, one or more of the central authorization system 101 and the rights holder system 117 may be configured to publish a second message indicating the success of the transaction to processing nodes 109 for incorporation into distributed public data structure 111. For example, central authorization system 101 may be configured to receive confirmation of at least one of the transfer of funds from account holder system 113, the modification of the cellular service plan of the first, and the receipt of direction by the rights holder system 117. In some aspects, in response to this confirmation, rights holder system 117 may be configured to publish a perfection message, in the manner described above with regards to FIGS. 3B and 5.

### Example 2D: Payment for Goods and Services

Consistent with disclosed embodiments, first user 105a may use the envisioned embodiments to purchase goods and services. First user 105a may have a pre-existing account with authorization system 100. First user 105a may have provisioned the account with funds, by transferring dollars to account holder system 113. Database 103 may store an authorization record for first user 105a indicating the dollars transferred to account holder system 113.

Consistent with disclosed embodiments, first user 105a may use origin device 105 to provide a message requesting the purchase of at least one of a good and a service from at least one business institution. In some aspects, the request may indicate the least one business institution. In various aspects, the request may indicate the at least one of a good and a service. In certain aspects, the request may indicate an individual recipient of the at least one of a good and a service. As a non-limiting example, the request may indicate that a basket of school supplies, provided by different business institutions, should be delivered to an individual.

Central authorization system 101 may authenticate the request and may provide a verification message. The verification message may indicate the business institutions supplying the at least one of a good and a service. The verification message may indicate the purchase price. The verification message may indicate fees assessed by one or more of the central authorization system 101 and the at least one business institution. In response, first user 105a may use origin device 105 to provide a message confirming the purchase.

Consistent with disclosed embodiments, rights holder system 117 may comprise rights holder systems associated with the at least one business institution. These rights holder systems may be part of, or may be configured to interact with, order fulfillment systems of the at least one business institution. For example, the rights holder systems may comprise electronic interfaces for ordering goods and services, according to methods known to one of skill in the art. Central authorization system 101 may be configured to provide information necessary for placing an order for the goods and services. For example, central authorization system 101 may be configured to provide inventory information and shipping information for delivery of goods to first user 105a, or another user. Central authorization system 101 may be configured to provide this information within a day, an hour, a minute, or in real-time, as would be appreciated by one of skill in the art. In this manner, a user may interact with the disclosed systems and methods to order goods and/or services from one or more business institutions.

In some embodiments, the at least one business institution associated with the rights holder system 117 may be a financial institution, and the order of goods and/or services may comprise a transfer of funds into an account held by the at least one business institution. For example, first user 105a may use the envisioned systems and methods to withdraw or deposit money into an account maintained by the financial institution associated with rights holder system 117.

Consistent with disclosed embodiments, central authorization system 101 may also be configured to access database 103 to update authorization records associated with the user. For example, central authorization system 101 may also be configured to access database 103 to decrement a balance for the account of the first user 105a. The balance may be decremented by the total cost of the at least one of a good and a service, including any fees collected by the central authorization system 101 and/or the at least one business institution. Such updating may occur within a day, an hour, a minute, or in real-time, as would be appreciated by one of skill in the art.

Consistent with disclosed embodiments, central authorization system 101 may be configured to also direct account holder system 113 to transfer funds associated with first user 105a to the at least one business institution, or to transfer funds from the at least one business institution to account holder system 113. As a non-limiting example, central authorization system 101 may direct account holder system 113 to initiate an automated clearing house transaction between account holder system 113 and one or more financial institutions associated with the at least one business institution. In certain aspects, such automated clearing house transactions may be bundled into larger transactions that are executed periodically. For example, each day's outstanding transactions may be bundled into a single, larger transaction for daily execution. One of skill in the art would recognize that such bundling may occur over a variety of time periods and the above example is not intended to be limiting.

Consistent with disclosed embodiments, central authorization system 101 may also be configured to publish a first message to processing nodes 109 for incorporation into distributed public data structure 111. The first message may be a creation message, in the manner described above with regards to FIGS. 3A and 4. In some aspects, grant information 305 may indicate at least one of a good and/or service, information regarding the business institution providing the good and/or service (e.g. an identifier of the business institution or a merchant code), a recipient a good and/or service, shipping information, an order time or date, or other information related to the purchase of the at least one of a good or a service. In some embodiments, a single first message may be published for each transaction. In various embodiments, a first messages may be published for each business institution providing a good and/or service in the transaction.

In some embodiments, one or more of the central authorization system 101 and the rights holder system 117 may be configured to publish a second message indicating the success of the transaction to processing nodes 109 for incorporation into distributed public data structure 111. For example, central authorization system 101 may be configured to receive confirmation of at least one of the transfer of funds from account holder system 113, the shipping or successful receipt of the goods, and the confirmation of receipt of the information necessary for placing the order for the goods and services by the rights holder system 117. In some aspects, in response to this confirmation, rights holder system 117 may be configured to publish the second message. The second message may be a perfection message, in the manner described above with regards to FIGS. 3B and 5. In some aspects, central authorization system 101 may be configured to publish a single second message for each transaction. In various embodiments, second messages may be published for each business institution providing a good and/or service in the transaction.

### Example 2E: Financial Account

Consistent with disclosed embodiments, first user 105a may use the envisioned embodiments to manage money in a financial account. In some embodiments, first user 105a may have a pre-existing account with authorization system 100. In some embodiments, first user 105a may have provisioned this account with funds, by transferring funds to account holder system 113. In various embodiments, first user 105a may interact with a broker to send funds to themselves, according to the disclosed systems and method, increasing the funds in their account. In some embodiments, when account holder system 113 comprises a plurality of account holder systems, first user 105a may provide a message to central authorization system 101 specifying the account holder systems associated with the funds owed the first user 105a. For example, first user 105a may specific that funds associated with a first account holder system in a first geographic location be disassociated with the first account holder system and associated with a second account holder system in a second geographic location.

### Example 2F: Automatic Loan Payment Collection

Consistent with disclosed embodiments, second user 107a may use the envisioned embodiments to make or obtain a loan. In some embodiments, the lendor may be a business institution, for example a business institution associated with rights holder system 117. In certain embodiments, the loan may be provided by a registered user of authorization system 100.

Central authorization system 101 may be configured to publish a creation message (e.g., creation message 301) including information specifying the terms of the loan (e.g. grant information 305). For example, this information may include at least one of an identification of the lendor, an identification of the lendee, a payment amount, a number of payments, an interest rate, payment conditions, late fees or penalties, and other information describing the loan. In the manner described above, when funds are provided to second user 107a, the central authorization system 101 may collect fees. Central authorization system 101 may similarly be configured to collect, from funds provided to second user 107a, an amount for application to the payments required by the loan. In some aspects, this amount may be predetermined. For example, this amount may be a predetermined amount, or a predetermined percentage of the funds provided to second user 107a. Additionally or alternatively, central authorization system 101 may be configured to receive funds for the payments required by the loan. For example, second user 107a (or another user) may use authorization system 100 to provide an amount for allocation towards the payments required by the loan. The allocation of the funds collected in this manner to any payment, principle, or penalties due under the terms of the loan may vary, as would be recognized by one of skill in the art, and are not intended to be limiting. Central authorization system 101 may be configured to publish a perfection message indicating the application of the collected funds. This perfection message may indicate an association between the applied funds and the original loan.

In some embodiments, central authorization system 101 may be configured to publish a creation message for the payment, in the manner described above with regards to FIG. 4. The lendor may then perfect this payment in the manner described above with regards to FIG. 5. In some aspects, central authorization system 101 may be configured to access database 103 to update an authorization record for the lendor, for example by incrementing an amount associated with the lendor. In certain embodiments, central authorization system 101 may be configured to direct account holder system 113 to transfer the payment to rights holder system 117, when the lendor is a business institution associated with rights holder system 117, according to methods known to one of skill in the art.

Should the lendee fail to satisfy a condition of the loan, for example by missing a payment, central authorization system 101 may be configured to publish a message to distributed public data structure 111 documenting this failure.

The foregoing disclosed embodiments have been presented for purposes of illustration only. This disclosure is not exhaustive and does not limit the claimed subject matter to the precise embodiments disclosed. Those skilled in the art will appreciate from the foregoing description that modifications and variations are possible in light of the above teachings or may be acquired from practicing the inventions. In some aspects, methods consistent with disclosed embodiments may exclude disclosed method steps, or may vary the disclosed sequence of method steps or the disclosed degree of separation between method steps. For example, method steps may be omitted, repeated, or combined, as necessary, to achieve the same or similar objectives. In various aspects, non-transitory computer-readable media may store instructions for performing methods consistent with disclosed embodiments that exclude disclosed method steps, or vary the disclosed sequence of method steps or disclosed degree of separation between method steps. For example, non-transitory computer-readable media may store instructions for performing methods consistent with disclosed embodiments that omit, repeat, or combine, as necessary, method steps to achieve the same or similar objectives. In certain aspects, systems need not necessarily include every disclosed part, and may include other undisclosed parts. For example, systems may omit, repeat, or combine, as necessary, parts to achieve the same or similar objectives. Accordingly, the claimed subject matter is not limited to the disclosed embodiments, but instead defined by the appended claims in light of their full scope of equivalents.

What is claimed is:

1. A central authorization system for publicly verifiable authorization, comprising:
a database storing authorization records;
at least one processor; and
at least one non-transitory memory storing instructions that, when executed by the at least one processor, cause the central authorization system to perform operations comprising:
receiving, from an origin device, a first grant request comprising grant information and second user contact information,
creating an authorization request entry in the database,
publishing, to the processing nodes, an encrypted creation message for incorporation into a distributed public data structure, the encrypted creation message indicating the grant information, and
providing a grant request indication to the second user, the grant request indication comprising a perfection code enabling decryption of the encrypted creation message.

2. The system of claim 1, the operations further comprising,
receiving, from a destination device, a perfection request, the perfection request comprising the perfection code;
publishing, to the processing nodes, based on the received perfection request, a perfection message for incorporation into the distributed public data structure, the perfection message comprising a reference to the encrypted creation message and the perfection code; and
granting the first grant request by updating the authorization records according to the authorization request entry.

3. The system of claim 1, the operations further comprising,
receiving, from a destination device, a transfer request, the transfer request comprising the perfection code;
publishing, to the processing nodes, based on the received transfer request, an encrypted transfer message for incorporation into the distributed public data structure, the encrypted transfer message comprising a reference to the encrypted creation message and the perfection code; and
providing a second grant request indication, the second grant request indication comprising a second perfection code enabling decryption of the encrypted transfer message.

4. The system of claim 3, wherein the transfer request further comprises second grant information, and the transfer message further comprises the second grant information.

5. The system of claim 4, wherein the transfer request further comprises third user contact information, and the second grant request indication is provided to the third user.

6. The system of claim 1, wherein the first grant request further comprises origin credentials, and the operations further comprise:
authenticating the origin credentials;
providing a verification message to the origin device; and
receiving a confirmation message from the origin device in response to the verification message.

7. The system of claim 6, wherein authenticating the origin credentials further comprises determining a first authorization record of the authorization records, the first authorization record associated with the origin device, and determining a sufficiency of the first authorization record based on the grant information.

8. The system of claim 2, wherein the perfection request further comprising destination credentials, and wherein the operations comprise authenticating the destination credentials in response to the perfection request.

9. The system of claim 8, wherein authenticating the destination credentials comprises determining a second authorization record of the authorization records, the second authorization record associated with the destination device.

10. The system of claim 1, wherein the perfection code enables generation of a cryptographic key for decrypting the encrypted creation message.

11. The system of claim 1, wherein the perfection code comprises a cryptographic key for decrypting the encrypted creation message.

12. The system of claim 1, wherein a plurality of encrypted creation messages comprise the encrypted creation message, and the encrypted creation message comprises a reference to one of the plurality of encrypted creation messages.

13. A method for publicly verifiable authorization, comprising:
receiving, from an origin device, a first grant request comprising grant information and second user contact information;
creating an authorization request entry in a database storing authorization records;
publishing, to the processing nodes, an encrypted creation message for incorporation into a distributed public data structure, the encrypted creation message indicating the grant information; and
providing a grant request indication to the second user, the grant request indication comprising a perfection code enabling decryption of the encrypted creation message.

14. The method of claim 13, further comprising,
receiving, from a destination device, a perfection request, the perfection request comprising the perfection code;
publishing, to the processing nodes, based on the received perfection request, a perfection message for incorporation into the distributed public data structure, the perfection message comprising a reference to the encrypted creation message and the perfection code; and
granting the first grant request by updating the authorization records according to the authorization request entry.

15. The method of claim 13, further comprising,
receiving, from a destination device, a transfer request, the transfer request comprising the perfection code;
publishing, to the processing nodes, based on the received transfer request, an encrypted transfer message for incorporation into the distributed public data structure, the encrypted transfer message comprising a reference to the encrypted creation message and a second perfection code; and
providing a second grant request indication, the second grant request indication comprising a second perfection code enabling decryption of the encrypted transfer message.

16. The method of claim 15, wherein the transfer request further comprises second grant information, and the transfer message further comprises the second grant information.

17. The method of claim 16, wherein the transfer request further comprises third user contact information, and the second grant request indication is provided to the third user.

18. A non-transitory computer readable medium containing instructions that when executed by at least one processor of a device, cause the device to perform operations comprising:
receiving, from an origin device, a first grant request comprising grant information and second user contact information;
creating an authorization request entry in a database storing authorization records;
publishing, to the processing nodes, an encrypted creation message for incorporation into a distributed public data structure, the encrypted creation message indicating the grant information; and
providing a grant request indication to the second user, the grant request indication comprising a perfection code enabling decryption of the encrypted creation message.

19. The non-transitory computer readable medium of claim 18, the operations further comprising:
receiving, from a destination device, a perfection request, the perfection request comprising the perfection code;
publishing, to the processing nodes, based on the received perfection request, a perfection message for incorporation into the distributed public data structure, the perfection message comprising a reference to the encrypted creation message and the perfection code; and
granting the first grant request by updating the authorization records according to the authorization request entry.

20. The non-transitory computer readable medium of claim 18, the operations further comprising,
receiving, from a destination device, a transfer request, the transfer request comprising the perfection code, second grant information, and third user contact information;
publishing, to the processing nodes, based on the received transfer request, an encrypted transfer message for incorporation into the distributed public data structure, the encrypted transfer message comprising a reference to the encrypted creation message, the perfection code, and second grant information; and
providing a second grant request indication to a third user, the second grant request indication comprising a second perfection code enabling decryption of the encrypted transfer message.
